(19) United States
(12) Patent Application Publication
(10) Pub. No.: US 2007/0053622 A1
(43) Pub. Date: Mar. 8, 2007

(54) Bearing support with an instrumented movement and coder for an information recorder unit

(75) Inventors: Samuel Gallion, Tours (FR); Franck Lauferon, Sonzay (FR)

Correspondence Address: MEYERTONS, HOOD, KIVLIN, KOWERT & GOETZEL, P.C., 700 LAVACA, SUITE 800, AUSTIN, TX, 78701, US

(73) Assignee: AKTIEBOLAGET SKF, 415 50 GOTEBORG (SE)

(21) Appl. No.: 10/562,476

(22) PCT Filed: Jun. 22, 2004
(86) PCT No.: PCT/FR04/01557

§ 371 Date: Jul. 3, 2006

(30) Foreign Application Priority Data
Jun. 27, 2003 (FR) 03/07772

(51) Int. Cl. F16C 41/04

(52) U.S. Cl. 384/448

(57) ABSTRACT

The invention relates to a bearing support with an instrumented movement (1), comprising a non-rotating bush (2), a rotating bush (3), roller elements (4), arranged between the rotating (3) and non-rotating (2) bushes and an information recorder unit, with a sensor (7) and a coder (8), comprising a substrate (16) made from an electrically non-conducting material and a thin layer (17) of electrically-conducting material, supported by the substrate (16). The substrate (16) is fixed in rotation with the rotating bush (3).

### BACKGROUND OF THE INVENTION

1. Field of the Invention

The present invention relates to the field of encoders able to collaborate with a sensor with a view to detecting a movement, particularly the rotational movement of a rotating part with respect to a non-rotating part.

2. Description of the Relevant Art

Generally an encoder is generally mounted on the rotating part while the sensor is mounted on the non-rotating part, although the set-up is reversed in certain applications.

The sensor is capable of delivering a signal enabling the value of a parameter that is to be measured, such as the displacement, the position, the speed or the angular acceleration of the rotating part to be determined. The active part of the encoder, which collaborates with one or several sensors, includes encoding elements the shape and structure of which depend on the type of sensor with which the encoder works.

In numerous applications, the rotating part is a rotating ring of a rolling bearing the non-rotating ring of which supports the sensor.

Metal encoders include an operational part which is made of an electrically conducting material, the geometry of which allows a suitable signal to be generated with the appropriate sensor or sensors, such as microcoil-type inductive sensors. Such devices are known, for example, from French patent applications 0208263 and 0208264 and are satisfactory.

In the known devices, at least the active part of the encoder is made of metal, generally by cutting and possibly by pressing a sheet metal strip.

Such an encoder does, however, have a number of disadvantages.

The encoder has a mass and an inertia that are relatively high, something which is rarely desirable. An encoder, the active part of which is of the eccentric type, gives rise to a not insignificant amount of imbalance at high rotational speeds. Furthermore, the shape of the teeth or of the windows is not always very strict if conventional manufacturing processes such as press cutting are to be used with a view to obtaining a reasonable cost price. Some tooth or window shapes are also difficult to achieve from a sheet metal blank because of the complexity of the shape and/or of the small dimensions of the teeth or of the windows. The difficulty in obtaining teeth or windows of constant geometry manifests itself in unevennesses that are detrimental to the sensor output signal quality.

The invention proposes to remedy these disadvantages.

### SUMMARY OF THE INVENTION

Described herein are embodiments of an encoder of low mass, small bulk, practically devoid of any imbalance, and that is economical to manufacture.

More specifically, described herein are embodiments of an encoder exhibiting great lightness of weight, low inertia and capable of rotating at high speed without imbalance and without friction, irrespective of the shape of the active part of the encoder the center of inertia of which may be located completely away from the axis of rotation of the system with no impact on the overall imbalance of the encoder wheel.

The instrumented rolling bearing, according to one embodiment, is of the type including a non-rotating ring, a rotating ring, at least one row of rolling elements positioned between two raceways of the rotating and non-rotating rings, and an information sensor assembly including a non-rotating sensor unit and a rotating encoder provided with an active part.

The encoder includes a substrate made of electrically non-conducting material and an electrically conducting thin layer supported by the substrate, the substrate rotating as one with the rotating ring. The substrate may be made of a synthetic material that is considerably lower in density than steel. This then yields an encoder of lower mass and inertia. Furthermore, the electrically conducting thin layer may exhibit an eccentric shape, of which the influence on the information of imbalance is negligible.

This is because the small thickness of the thin layer by comparison with the thickness of the substrate means that the overall center of inertia of the annular encoder wheel varies practically not at all with the shape of the metal deposit and remains more or less situated on the axis of rotation.

Advantageously, the substrate is annular. This then reduces any imbalance that there might be. The substrate may have the overall shape of a disk. The substrate, of planar shape, can thus be manufactured from a conventional printed circuit board. The cost price of the encoder therefore remains reasonable.

In one embodiment, the sensor unit includes at least one inductive sensor. The sensor unit may include at least one microcoil. It is thus possible to enjoy a sensor unit of low bulk.

In one embodiment, the electrically conducting thin layer includes a plurality of angular sectors separated from one another. The electrically conducting thin layer may form a plurality of teeth each occupying a determined constant or non-constant angle. These teeth may be arranged in one or more concentric rings with a view to collaborating with one or more radially stepped sensors.

In another embodiment, the electrically conducting thin layer is circularly continuous. The electrically conducting thin layer may be delimited by two circles which are eccentric with respect to one another. One of the circles may be concentric with the substrate of the encoder. The small thickness of the thin layer which, in spite of its eccentricity, has no significant effect on the imbalance, can thus be enjoyed.

In one embodiment, the substrate is pushed onto a land of the rotating ring. Said land may be cylindrical and centered on the axis of the rolling bearing. Said land may be positioned radially between the bottom of the raceway for the rolling elements and the cylindrical surface opposite, for example the bore of a rotating inner ring.

In another embodiment, the substrate is bonded to the rotating ring. It is thus possible to avoid any special machining of a land and to use a rotating ring of standard type, something which is particularly economical.

In another embodiment, the substrate is trapped against a radial surface of the rotating ring. The substrate may be trapped between said radial surface of the rotating ring and a radial surface formed by a step of the housing or of the shaft of the rotating ring.

In one embodiment, the device includes an encoder support mounted on a cylindrical surface of the rotating ring. The encoder support may be made of a synthetic material of low density, or alternatively may be made of light metal alloy. The encoder support may be pushed onto the rotating ring, for example into the bore of an outer ring or onto the exterior cylindrical surface of an inner ring, of standard type. The encoder support may also be bonded to the rotating ring or alternatively be trapped against the rotating ring.

Also described is an encoder provided with an active part and intended for an information sensor assembly which includes a sensor unit able to collaborate with the encoder. The encoder includes a substrate made of electrically non-conducting material and an electrically conducting thin layer supported by the substrate.

Advantageously, the thin layer is made of copper with, possibly, a very fine finishing layer of gold or of silver. However, it is also possible to conceive of producing the thin layer in any other electrically conducting metal that can be deposited and, if necessary, etched on a printed circuit board.

Advantageously, the thin layer has a thickness of between 5 and 100 microns.

Encoders described wherein are particularly light in weight, easy to mount on a rotating part and are designed such that the detrimental influence on any imbalance is entirely negligible.

### BRIEF DESCRIPTION OF THE DRAWINGS

The present invention will be better understood from studying the detailed description of a number of embodiments taken by way of nonlimiting examples and illustrated by the attached drawings, in which:

FIG. 1 is a view in axial section of a rolling bearing according to a first embodiment of the invention;

FIG. 2 is a front elevation of an encoder according to one aspect of the invention;

FIG. 3 and 4 show variants of FIG. 2; and

FIGS. 5 to 8 are half-views in axial section of a rolling bearing according to various embodiments of the invention.

While the invention is susceptible to various modifications and alternative forms, specific embodiments thereof are shown by way of example in the drawings and will herein be described in detail. It should be understood, however, that the drawing and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

As illustrated in FIG. 1, the rolling bearing 1 includes an outer ring 2, an inner ring 3, a row of rolling elements 4, in this instance balls, positioned between the outer ring 2 and the inner ring 3 and held by a cage 5, a seal 6 secured to the outer ring 2 and rubbing against the inner ring 3, a sensor 7 secured to the outer ring 2 and an encoder 8 secured to the inner ring 3.

More specifically, the outer ring 2 will generally be a non-rotating ring, while the inner ring 3 will be used as a rotating ring. However, in some applications it is desirable to gain rotation information about a rotating part. The encoder is then positioned secured to the non-rotating ring while the sensor is mounted secured to the rotating ring. Furthermore, it is perfectly conceivable to provide a sensor secured to the inner ring and an encoder secured to the outer ring, whether the latter be a rotating or a non-rotating ring.

The outer ring 2 is of solid type, including a toroidal raceway 2a for the rolling elements 4, an exterior cylindrical surface 2b, transverse radial surfaces 2c and 2d and a cylindrical bore 2e. Grooves 9 and 10 are formed in the bore 2e near the radial surfaces 2c and 2d and have an annular shape. The seal 6 is mounted in the groove 9 while the sensor 7 is mounted in the groove 10 while at the same time being in contact with the radial surface 2d.

The inner ring 3 has a toroidal raceway 3a for the rolling elements 4, a cylindrical bore 3b, radial transverse surfaces 3c and 3d respectively coplanar with the radial surfaces 2c and 2d of the outer ring 2, and an outer cylindrical surface 3e. A cylindrical land 3f is formed, by machining, from the outer cylindrical surface 3e while at the same time being adjacent to the radial surface 3d. The diameter of the land 3f ranges between the diameter of the bore 3b and the diameter of the bottom of the raceway 3a so as to form a radial space for the encoder 8.

The sensor 7 includes a metal support 11, of angular overall shape, provided with a hook-forming part 11a projecting into the groove 10 of the outer ring 2, a radial part 11b in contact with the radial surface 2d of the outer ring 2 and a substantially axial part 11c extending outward from the large-diameter end of the radial part 11b.

The sensor 7 also includes a body 12 made of a synthetic material and exhibiting an annular overall shape. The body 12 is radially surrounded by the axial part 11c of the support 11 and includes a wire terminal 12a projecting outward to allow an electric lead 13 to pass. The wire terminal is positioned in a cut-out formed in the axial part 11c of the support 11.

The sensor 7 is supplemented by a printed circuit board 14 occupying a limited angular sector and positioned in the body 12 while at the same time being exposed on the same side as the rolling elements 4, and electronic components 15, particularly microcoils, positioned on that face of the printed circuit board 14 that faces toward the rolling elements 4.

The encoder 8 includes a substrate 16 in the form of a flat annulus made from a printed circuit board, for example in epoxy resin, and an electrically conducting thin layer 17, for example of copper, formed on a face of the substrate 16 which is electrically non-conducting.

The encoder 8 is mounted by push-fitting the bore of the substrate 16 onto the cylindrical land 3f of the inner ring 3, the thin layer 17 facing the sensor 7 and, in particular, facing the electronic component 15.

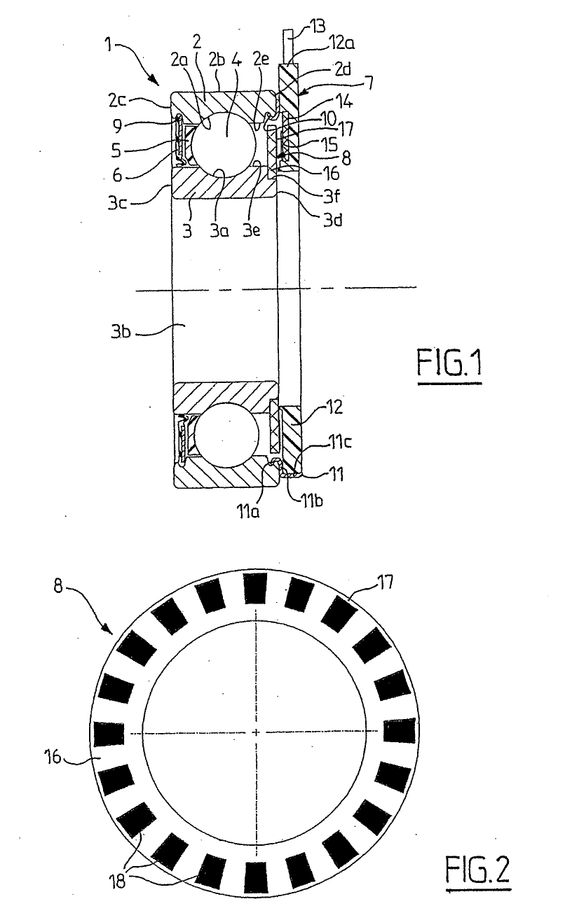

In the embodiment illustrated in FIG. 2, the electrically conducting thin layer 17 is in the form of a plurality of distinct regions separated from one another and delimited in the radial direction by two circles concentric with the substrate 16 and in the circumferential direction occupying a constant angle of the order of 9°. Between two electrically conducting regions the substrate 16 remains bare, devoid of electrically conducting elements.

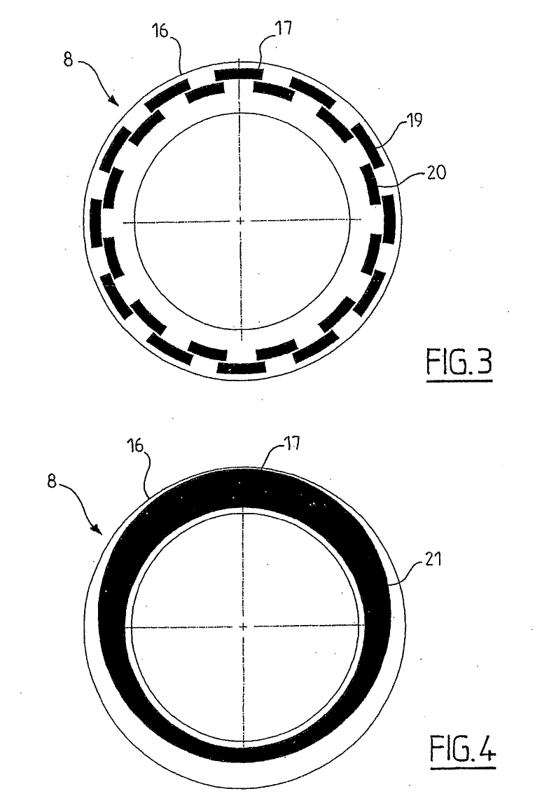

In the embodiment illustrated in FIG. 3, the encoder 8 includes a substrate 16 identical to that of the preceding embodiment and an electrically conducting thin layer 17 formed of regions 19 and 20. The regions 19 are radially delimited by two circles concentric with the substrate 16, having a diameter greater than the two circles concentric with the substrate 16 delimiting the regions 20. The regions 19 and 20 are thus radially spaced apart and may occupy redundant angular sectors. In other words, the regions 19 and 20 have some angular overlap. Between two electrically conducting regions the substrate 16 remains bare, devoid of electrically conducting elements.

In the embodiment illustrated in FIG. 4, the electrically conducting thin layer 17 occupies a single region 21, of circular shape, internally delimited by a circle concentric with the substrate 16 and externally delimited by a circle offset from the inner circle. The region 21 therefore has significant eccentricity, its maximum radial height being possibly more than twice its minimum radial height. The thickness of the thin layer 17 is generally less than 100 microns, its influence on any imbalance that there might be is entirely negligible, something which would not be the case with a solid metal encoder wheel.

In the embodiment illustrated in FIG. 5, the rolling bearing is similar to that of FIG. 1 except that the inner ring 3 is of standard type, with no machined land 3f. The inner ring 3 is mounted on a shaft 22 exhibiting an external cylindrical surface 23 bounded by a radial shoulder 24. The encoder 8, the bore of which has dimensions more or less equal to the bore 3b of the inner ring 3, is mounted on the cylindrical surface 23 of the shaft 22, in contact on one side with the radial shoulder 24 and, on the other side, with the radial surface 3b of the inner ring 3. The radial surface 3c of the inner ring 3 is in contact with a washer or spacer 25 that a clamping member, not depicted, such as a nut, clamps axially against the face 3c of the inner ring 3. Thus, a small-diameter region of the substrate 16 of the encoder 8 is trapped axially between the inner ring 3 and the shoulder 24 of the shaft 22 and therefore rotates as one with said inner ring 3 and said shaft 22.

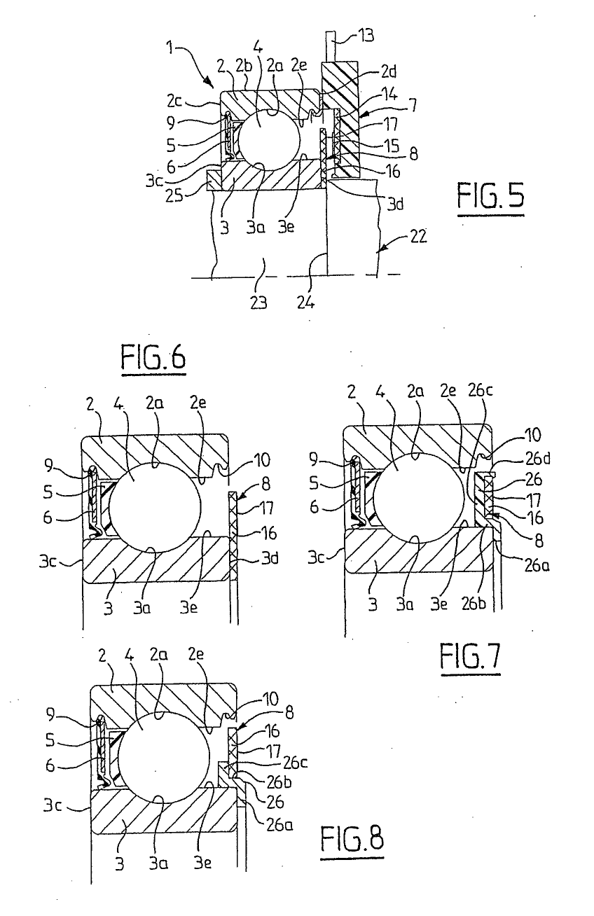

In the embodiment illustrated in FIG. 6, the encoder 8 is similar to that of FIG. 5 with a bore more or less equal to the bore of the inner ring 3. The substrate 16 here is bonded to the radial surface 3d of the inner ring 3 and secured to the bearing 1 before it is mounted on a shaft.

In the embodiment illustrated in FIG. 7, the rolling bearing 1 further includes an encoder support 26 made of synthetic material, for example of elastomer, of annular overall shape. The support 26 includes a radial wall 26a projecting inward and in contact with the radial surface 3d of the inner ring 3, an axial wall 26b meeting the large-diameter end of the radial wall 26a and pushed onto the cylindrical outer surface 3e of the inner ring 3, a radial wall 26c meeting the axial wall 26b near the rolling elements 4 and extending outward and an axial wall 26d meeting the large-diameter end of the radial wall 26c and extending away from the rolling elements 4. The axial 26b, radial 26c and axial 26d walls define an annular housing in which the encoder 8 is positioned, of which encoder the substrate 16 may have a small axial and radial dimension. A slight radial lip facing inward or claws may possibly be provided at the free end of the axial wall 26d to retain the substrate axially.

The radial wall 26a allows the encoder 8 and the support 26 to be accurately positioned in the axial direction with respect to the inner ring 3. The axial wall 26b allows for pushing onto the inner ring 3. The axial walls 26b and 26d form means for axially retaining the encoder 8, while the radial wall 26c forms a means for precisely axially positioning the encoder 8, allowing it to collaborate with a sensor from which it is separated by a small gap.

The embodiment illustrated in FIG. 8 is similar to the previous one except that the support 26, made of metal, for example of light alloy, includes radial 26a and axial 26b walls similar to those illustrated in FIG. 7 whereas the radial wall 26c is of smaller size, markedly smaller than the radial dimension of the substrate 16. The substrate 16 can therefore be pushed onto the support 26 or alternatively bonded.

It will be understood that, in all cases, it is possible to supplement the push-fit with bonding.

By virtue of the invention it is thus possible to obtain an encoder wheel for a rolling bearing that has very low inertia, in which the metallized active part can be made with great precision and is not restricted by the complexity of the shapes, hence improving the precision of the sensor output signal.

The use of more complex shapes such as those illustrated in FIG. 3 makes it possible to increase the number of sensors and thereby increase the precision of the detection.

Finally, the active part, of very small thickness, has a negligible influence on any imbalance there might be. The structure of the encoder allows it easily to be mounted in a rolling bearing.

Of course, it must be understood that the sensor and the encoder are not in mutual contact.

A sensor and an encoder in mechanical contact with one another would produce unacceptable levels of heating and would destroy the encoder.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description to the invention. Changes may be made in the elements described herein without departing from the spirit and scope of the invention as described in the following claims. In addition, it is to be understood that features described herein independently may, in certain embodiments, be combined.

1. An instrumented rolling bearing comprising a non-rotating ring, a rotating ring, at least one row of rolling elements positioned between two raceways of the rotating and non-rotating rings, and an information sensor assembly comprising a non-rotating sensor unit and a rotating encoder provided with an active part, the encoder and the sensor unit being separated by a gap, wherein the encoder comprises a substrate made of electrically non-conducting material and an electrically conducting thin layer supported by the substrate, the substrate rotating as one with the rotating ring.

2. The device as claimed in claim 1, wherein the substrate is annular.

3. The device as claimed in claim 2, wherein the substrate has the overall shape of a disk.

4. The device as claimed in claim 1, wherein the sensor unit includes at least one inductive sensor.

5. The device as claimed in claim 1, wherein the sensor unit includes at least one microcoil.

6. The device as claimed in claim 1, wherein the electrically conducting thin layer comprises a plurality of angular sectors separated from one another.

7. The device as claimed in claim 1, wherein the electrically conducting thin layer is circularly continuous.

8. The device as claimed in claim 7, wherein the electrically conducting thin layer is delimited by two circles which are eccentric with respect to one another.

9. The device as claimed in claim 1, wherein the substrate is pushed onto a land of the rotating ring.

10. The bearing as claimed in claim 1, wherein the substrate is bonded to the rotating ring.

11. The bearing as claimed in claim 1, wherein the substrate is trapped against a radial surface of the rotating ring.

12. The bearing as claimed in claim 1, further comprising an encoder support mounted on a cylindrical surface of the rotating ring.

13. An instrumented rolling bearing comprising a non-rotating ring, a rotating ring, at least one row of rolling elements positioned between two raceways of the rotating and non-rotating rings, a non-rotating sensor unit and a rotating encoder provided with an active part, the encoder and the sensor unit being separated by a gap, wherein the encoder comprises a substrate made of electrically non-conducting material and an electrically conducting thin layer supported by the substrate, the substrate rotating as one with the rotating ring.
